(19) United States
(12) Patent Application Publication
(10) Pub. No.: US 2006/0017407 A1
(43) Pub. Date: Jan. 26, 2006

(54) Decoration with twinkling light string

(76) Inventor: Jung Kuei Wang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/878,376

(22) Filed: Jun. 29, 2004

(51) Int. Cl. H05B 37/00; H05B 39/00; H05B 41/00

(52) U.S. Cl. 315/312

(57) ABSTRACT

A decoration with twinkling light strings includes at least two frames for connecting with relating light strings. A controlling bulb or a relay is provided on the main light string to control the main string and the connecting string being lightened at different time or at the same time. The decoration can then obtain a twinkling lighting effect to display a batter shining outlook.

### BACKGROUND OF THE INVENTION

In festival or holidays, a light string is usually used for increasing happy sense. There are many kinds of decorative light strings with various patterns conventionally. These known decorations have a single light string to display monologue lighting effect in usual. Hence, the prior structure can not provide a perfect decorative purpose.

### SUMMARY OF THE INVENTION

The present invention is to provide a decoration with twinkling light strings, which are connected with frames of the decoration respectively. Each string is connected with a respective frame while it can be controlled to lighten in interval relating another one for obtaining a various and novel decorative effect. Now, accompanying with the following drawings, the character of the present invention will be described here and after.

### BRIEF DESCRIPTION OF THE DRAWINGS

FIG. 1 is a perspective view showing a decoration with twinkling light strings according to the present invention.

FIG. 2 is a perspective view of FIG. 1 showing different lighting effect of the decoration.

FIG. 3 is a view showing an electrical circuit of two connecting light strings according to the present invention.

FIG. 4 is a perspective view showing a controlling bulb according to the present invention.

FIG. 5 is a perspective view of FIG. 4 showing a separating position of the controlling bulb.

### DETAILED DESCRIPTION OF THE PREFERRED EMBODIMENT

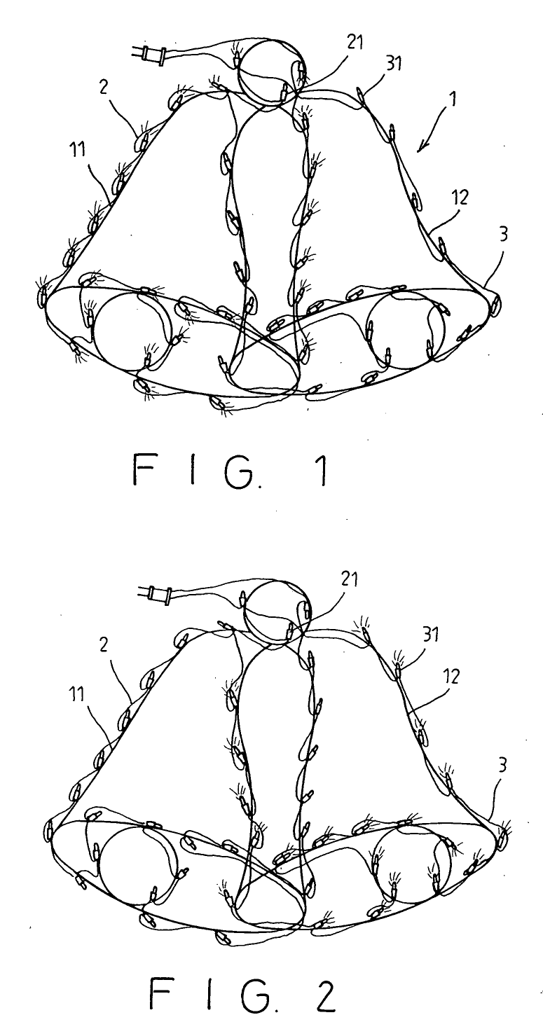

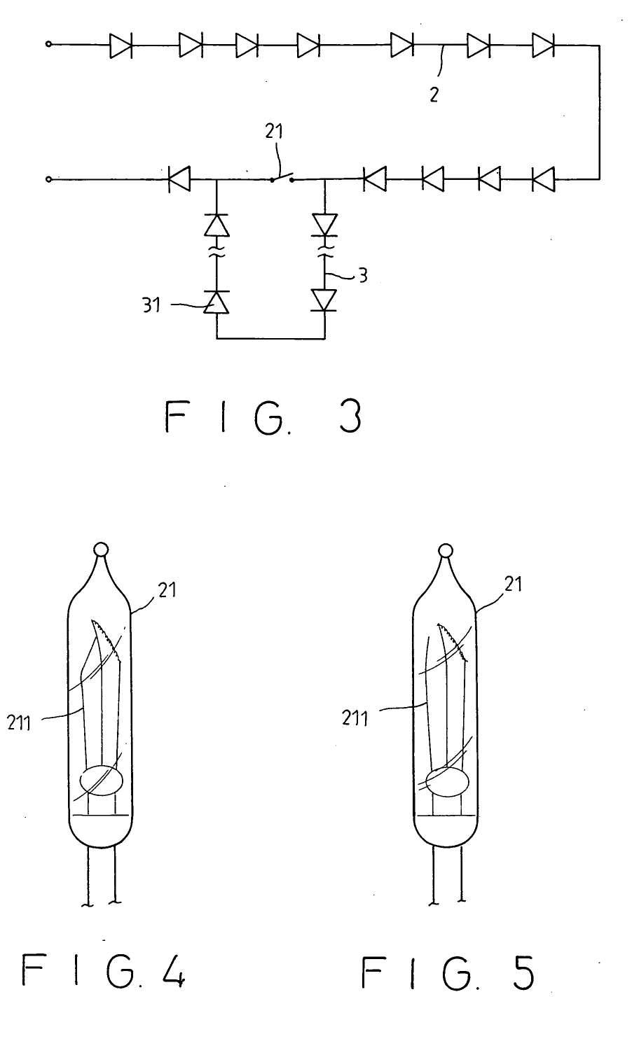

Please referring to FIG. 1 to 3, the present invention includes a decoration (1), which has at least two frames (11), (12) for connecting with two relating light strings (2), (3). The main light string (2) is provided with a controlling bulb or a relay (21). The other connecting light string (3) has its two ends to connect with two terminals of the controlling bulb or the relay (21), as shown in FIG. 3, to become a parallel connection relating to the main light string (2). The bulbs (31) on the connecting light string (3) have high resistance value than the bulbs of the light string (2). Accordingly, when the relay (21) is on, the current will only pass through the light string (2) that causes only the frame (11) with lighting effect.

When the controlling bulb or the relay (21) is off, the current must flow through the light string (3) as well as the main string (2). Hence, both frames (11), (12) connecting with two strings (2), (3) are lightened. The decoration (1) with two frames will then obtain the twinkling effect between two light strings as the controlling bulb or the relay (21) is on or off in time interval automatically.

Please referring to FIG. 4 and 5, it shows an embodiment of the controlling bulb (21) according to present invention. The bulb (21) includes a dual-metal slice (211) having different coefficients of heat transfer inside. When the slice (211) is heated or cool, it can be bent to different directions, such as in position of FIG. 4 to connect the circuit, or in position of FIG. 5 to separate the connection. It can reach the twinkling effect for increasing the decorative purpose.

I claim:

1. A decoration with twinkling light strings including a decoration having at least two frames for connecting with two relating light strings, one main string is provided with a controlling bulb or a relay and the other connecting light string has its two ends to connect with two terminals of the controlling bulb or the relay to become a parallel connection relating to the main light string, the bulbs on the connecting light string having high resistance value than the bulbs of the main light string.

2. The decoration with twinkling light strings as claimed in claim 1, when the controlling bulb or the relay is on, only the bulbs on the main string are lightened, and when the controlling bulb or the relay is off, the bulbs on the connecting string are lightened at the same time.

3. The decoration with twinkling light strings as claimed in claim 1, wherein the controlling bulb or the relay is controlled automatically by change of heat or time.
